(19) United States
(12) Patent Application Publication
(10) Pub. No.: US 2025/0286579 A1
(43) Pub. Date: Sep. 11, 2025

(54) UNIVERSAL FRONT END MODULE

(71) Applicant: Skyworks Solutions, Inc., Irvine, CA (US)

(72) Inventors: Jose Mari Elizalde Harrison, Newburyport, MA (US); Andrew Raymond Chen, Newton, MA (US)

(21) Appl. No.: 19/072,860

(22) Filed: Mar. 6, 2025

Related U.S. Application Data
(60) Provisional application No. 63/563,225, filed on Mar. 8, 2024.

(51) Int. Cl. H04B 1/44; H04B 1/04

(52) U.S. Cl. CPC H04B 1/44; H04B 1/0483

(57) ABSTRACT

A radio frequency front end module with a controller configurable, based on a control input, to select from operating the radio frequency front end module in a first configuration or a second configuration, the first configuration and the second configuration corresponding to different radio frequency host systems. A transmit path is configurable in a first plurality of available states when the radio frequency front end module is operating in the first configuration and a second plurality of available states when the radio frequency front end module is operating in the second configuration. A receive path is configurable in a third plurality of available states when the radio frequency front end module is operating in the first configuration and a fourth plurality of available states when the radio frequency front end system is operating in the second configuration.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure relates generally to radio frequency (RF) front-end modules (FEMs). More particularly, aspects of the present disclosure relate to systems and methods enabling improved RF FEM performance and configurability due to compatibility with different control signals and/or different control interfaces.

### Description of the Related Technology

RF communication systems can be used for transmitting and/or receiving signals of a wide range of frequencies. For example, a RF communication system can be used to wirelessly communicate RF signals in a frequency range of about 30 kHz to 300 GHz, such as in the range of about 450 MHz to about 7.125 GHz for certain communications standards.

RF FEMs are used for RF signal reception (Rx) and transmission (Tx). In certain applications, RF communications systems can be simultaneously and/or multiply connected to one or more networks of the same and/or of different generations and at same, similar, or different bands and transmit and/or receive a plurality of RF signals simultaneously.

Modern RF systems (e.g., smart phones, tablets, computers, etc.) with modern RF FEMs may support WiFi (802.11 a/b/g/n/ax/ac/p) on a connectivity side of the system and/or many different radio access technologies (RATs), including 2G (GSM, GPRS, E-GPRS), 3G (CDMA2000, 1×-EVDO), 4G (LTE, LTE-A ProSE, eLAA, C-V2X) and 5G (NR sub-7 GHz, mmWave, NR-U) on a cellular portion of the system. These technologies are supported in hardware components from various manufacturers on the RF system forcing the RF FEMs to be customized for each RF system to be coordinated by the RF systems unique control signals.

When an RF system is transmitting, an RF signal is delivered to a RF FEM, which amplifies the RF signal, e.g., with minimal distortion, and drives it to the antenna to be transmitted to a remote client. Conversely, when the radio system is receiving, a possibly weak RF signal is received from a remote client and amplified before being delivered to the RF system for processing. These functions are coordinated by control signals from the RF system to the RF FEM included therein using instructions that are typically unique to the RF system.

The RF FEMs paired with RF system have largely similar requirements with some differences in performance or operating conditions. These differences mean that RF FEMs are typically customized for each RF system which may complicate manufacturing and increase costs.

### SUMMARY OF CERTAIN INVENTIVE CONCEPTS

According to certain aspects, the present application discloses universal RF FEMs configured and connected to accept control signals from multiple RF systems of e.g. different manufacturers to provide the performance needed for the respective application without complicating manufacturing and increasing costs.

The systems, methods, and devices of this disclosure each have several aspects, no single one of which is solely responsible for the desirable attributes disclosed herein.

In some aspects, the techniques described herein relate to a radio frequency front end module including: a controller configurable to operate the radio frequency front end module according to at least one of a first configuration and a second configuration; and at least one of: a first transmit path including a first power amplifier, the first transmit path configurable for communication in a first transmit frequency range according to a selected one of the first and second configuration; and a first receive path including a first low-noise amplifier, the first receive path configurable for communication in a first receive frequency range according to a selected one of the first and second configuration.

In some aspects, the techniques described herein relate to a radio frequency front end module wherein the first configuration corresponds to a first radio frequency system configured to include the radio frequency front end module and the second configuration corresponds to a second radio frequency system configured to include the radio frequency front end module.

In some aspects, the techniques described herein relate to a radio frequency front end module wherein the first radio frequency system and the second radio frequency system are different radio frequency systems having different transmit states and receive states.

In some aspects, the techniques described herein relate to a radio frequency front end module wherein the controller is configured to detect the first configuration or the second configuration corresponding to an radio frequency system in which the radio frequency front end module is included.

In some aspects, the techniques described herein relate to a radio frequency front end module further including at least one general purpose input/output pin coupled to the controller to detect the first configuration or the second configuration corresponding to an radio frequency system in which the radio frequency front end module is included.

In some aspects, the techniques described herein relate to a radio frequency front end module wherein the radio frequency front end module includes a plurality of general purpose input/output pins coupled to the controller to detect the first configuration or the second configuration corresponding to an radio frequency system in which the radio frequency front end module is included.

In some aspects, the techniques described herein relate to a radio frequency front end module wherein the controller is configured to operate the radio frequency front end module according to the first configuration or according to the second configuration corresponding to a logic table of a radio frequency system in which the radio frequency front end module is included.

In some aspects, the techniques described herein relate to a radio frequency front end module wherein the controller is configurable to operate the radio frequency front end module according to first control signals from the first radio frequency system and configurable to operate the radio frequency front end module according to second control signals from the second radio frequency system.

In some aspects, the techniques described herein relate to a radio frequency front end module wherein the controller is configured to be adapted to requirements of an radio frequency system in which the radio frequency front end module is included by software without requiring an adaptation or an update of hardware components of the radio frequency front end module.

In some aspects, the techniques described herein relate to a radio frequency front end module wherein the radio frequency front end module is integrally formed as a single component of an radio frequency system in which the radio frequency front end module is included.

In some aspects, the techniques described herein relate to a radio frequency system including a radio frequency front end module, the radio frequency front end module including: a controller configurable to operate the radio frequency front end module according to at least one of a first configuration and a second configuration; and at least one of: a first transmit path including a first power amplifier, the first transmit path configurable for communication in a first transmit frequency range according to a selected one of the first and second configuration; and a first receive path including a first low-noise amplifier, the first receive path configurable for communication in a first receive frequency range according to a selected one of the first and second configuration.

In some aspects, the techniques described herein relate to a radio frequency system wherein the first configuration corresponds to a first radio frequency system configured to include the radio frequency front end module and the second configuration corresponds to a second radio frequency system configurable to include the radio frequency front end module.

In some aspects, the techniques described herein relate to a radio frequency system wherein the first radio frequency system and the second radio frequency system are different radio frequency systems having different transmit states and receive states.

In some aspects, the techniques described herein relate to a radio frequency system wherein the controller is configured to detect the first configuration or the second configuration corresponding to an radio frequency system in which the radio frequency front end module is included.

In some aspects, the techniques described herein relate to a radio frequency system wherein the radio frequency front end module includes at least one general purpose input/output pin coupled to the controller to detect the first configuration or the second configuration corresponding to an radio frequency system in which the radio frequency front end module is included.

In some aspects, the techniques described herein relate to a radio frequency system wherein the radio frequency front end module includes a plurality of general purpose input/output pins coupled to the controller to detect the first configuration or the second configuration corresponding to an radio frequency system in which the radio frequency front end module is included.

In some aspects, the techniques described herein relate to a radio frequency system wherein the controller is configured to operate the radio frequency front end module according to the first configuration or according to the second configuration corresponding to a logic table of the radio frequency system in which the radio frequency front end module is included.

In some aspects, the techniques described herein relate to a radio frequency system wherein the controller is configurable to operate the radio frequency front end module according to first control signals from the first radio frequency system and configurable to operate the radio frequency front end module according to second control signals from the second radio frequency system.

In some aspects, the techniques described herein relate to a radio frequency system wherein the controller is configured to be adapted and/or updated to requirements of the radio frequency system in which the radio frequency front end module is included by software without requiring adaptation and/or update of a hardware of the radio frequency front end module.

In some aspects, the techniques described herein relate to a radio frequency system wherein the radio frequency front end module is integrally formed as a single component of the radio frequency system in which the radio frequency front end module is included.

In some aspects, the techniques described herein relate to a device including: a transceiver; and a radio frequency system including a radio frequency front end module, the radio frequency front end module including a controller configurable to operate the radio frequency front end module according to at least one of a first configuration and a second configuration, and at least one of: a first transmit path including a first power amplifier, the first transmit path configurable for communication in a first transmit frequency range according to a selected one of the first and second configuration, and a first receive path including a first low-noise amplifier, the first receive path configurable for communication in a first receive frequency range according to a selected one of the first and second configuration.

In some aspects, the techniques described herein relate to a device wherein the first configuration corresponds to a first radio frequency system configured to include the radio frequency front end module and the second configuration corresponds to a second radio frequency system configurable to include the radio frequency front end module.

In some aspects, the techniques described herein relate to a device wherein the first radio frequency system and the second radio frequency system are different radio frequency systems having different transmit states and receive states.

In some aspects, the techniques described herein relate to a device wherein the controller is configured to detect the first configuration or the second configuration corresponding to an radio frequency system in which the radio frequency front end module is included.

In some aspects, the techniques described herein relate to a device wherein the radio frequency front end module includes at least one general purpose input/output pin coupled to the controller to detect the first configuration or the second configuration corresponding to an radio frequency system in which the radio frequency front end module is included.

In some aspects, the techniques described herein relate to a device wherein the radio frequency front end module includes a plurality of general purpose input/output pins coupled to the controller to detect the first configuration or the second configuration corresponding to an radio frequency system in which the radio frequency front end module is included.

In some aspects, the techniques described herein relate to a device wherein the controller is configured to operate the radio frequency front end module according to the first configuration or according to the second configuration corresponding to a logic table of the radio frequency system in which the radio frequency front end module is included.

In some aspects, the techniques described herein relate to a device wherein the controller is configurable to operate the radio frequency front end module according to first control signals from the first radio frequency system and configurable to operate the radio frequency front end module according to second control signals from the second radio frequency system.

In some aspects, the techniques described herein relate to a device wherein the controller is configured to be adapted and/or updated to requirements of the radio frequency system in which the radio frequency front end module is included by software without requiring adaptation and/or update of a hardware of the radio frequency front end module.

In some aspects, the techniques described herein relate to a device wherein the radio frequency front end module is integrally formed as a single component of the radio frequency system in which the radio frequency front end module is included.

In some aspects, the techniques described herein relate to a radio frequency front end module including: a controller configurable, based on a control input, to select from operating the radio frequency front end module in a first configuration or a second configuration, the first configuration and the second configuration corresponding to different radio frequency host systems; and a transmit path including a power amplifier, and a receive path including a low-noise amplifier, the transmit path configurable in a first plurality of available states when the radio frequency front end module is operating in the first configuration and a second plurality of available states when the radio frequency front end module is operating in the second configuration, the receive path configurable in a third plurality of available states when the radio frequency front end module is operating in the first configuration and a fourth plurality of available states when the radio frequency front end module is operating in the second configuration.

In some aspects, the techniques described herein relate to a radio frequency front end module wherein the first plurality of available states partially overlaps with the second plurality of available states.

In some aspects, the techniques described herein relate to a radio frequency front end module wherein the third plurality of available states partially overlaps with the fourth plurality of available states.

In some aspects, the techniques described herein relate to a radio frequency front end module further including at least one general purpose input/output pin coupled to the controller, the controller selecting the first configuration or the second configuration based on information received on the at least one general purpose input/output pin that identifies a host radio frequency system in which the radio frequency front end module is included.

In some aspects, the techniques described herein relate to a radio frequency front end module wherein the first configuration corresponds to a host radio frequency system from a first supplier and the second configuration corresponds to a host radio frequency system from a second supplier.

In some aspects, the techniques described herein relate to a radio frequency front end module further including a package containing the controller, the transmit path, and the receive path.

In some aspects, the techniques described herein relate to a radio frequency front end module further including one or more switches configured to selectively connect the transmit path or the receive path to an antenna port of the radio frequency front end module.

In some aspects, the techniques described herein relate to a radio frequency front end module further including a filter, the controller configured to selectively configure the one or more switches to include the filter in the transmit path or the receive path depending on the current state of the respective path.

In some aspects, the techniques described herein relate to the radio frequency front end module of claim wherein the first plurality of available states are different than the second plurality of available states.

In some aspects, the techniques described herein relate to the radio frequency front end module of claim wherein the third plurality of available states are different than the fourth plurality of available states.

In some aspects, the techniques described herein relate to a mobile device including: an antenna; and a host radio frequency system including a packaged front end module, the packaged front end module including a controller configurable, based on a control input, to select from operating the packaged front end module in a first configuration or a second configuration, the first configuration and the second configuration corresponding to different radio frequency host systems, the packaged front end module further including a transmit path including a power amplifier, and a receive path including a low-noise amplifier, the transmit path configurable in a first plurality of available states when the packaged front end module is operating in the first configuration and a second plurality of available states when the packaged front end module is operating in the second configuration, the receive path configurable in a third plurality of available states when the packaged front end module is operating in the first configuration and a fourth plurality of available states when the packaged front end module is operating in the second configuration.

In some aspects, the techniques described herein relate to a mobile device wherein the first configuration corresponds to the host radio frequency system from a first supplier and the second configuration corresponds to a different host radio frequency system from a second supplier.

In some aspects, the techniques described herein relate to a mobile device wherein the first plurality of available states partially overlaps with the second plurality of available states.

In some aspects, the techniques described herein relate to a mobile device wherein the third plurality of available states partially overlaps with the fourth plurality of available states.

In some aspects, the techniques described herein relate to a mobile device wherein the controller is configured to be adapted to requirements of a radio frequency system in which the packaged front end module is included by software without requiring an adaptation or an update of hardware components of the packaged front end module.

In some aspects, the techniques described herein relate to a mobile device further including one or more switches configured to selectively connect the transmit path or the receive path to an antenna port of the front end module.

In some aspects, the techniques described herein relate to a mobile device further including an acoustic wave filter, the controller configured to selectively configure the one or more switches to include the acoustic wave filter in the transmit path in at least one state of the first plurality of available states.

In some aspects, the techniques described herein relate to a wireless communication device including: a radio frequency system of a first type of radio frequency system and configured to generate control signals; and a radio frequency front end module including a control interface configured to receive the control signals and, based on the control signals, select a first configuration to operate the radio frequency front end module in from a plurality of available configurations, the first configuration corresponding to the first type of radio frequency system, the radio frequency front end module further including a transmit path and a receive path, the transmit path configurable in a first plurality of available states when the radio frequency front end module is operating in the first configuration, the receive path configurable in a second plurality of available states when the radio frequency front end module is operating in the first configuration.

In some aspects, the techniques described herein relate to a wireless communications device wherein the radio frequency front end module further includes a controller configured to select the first operating configuration based on the control signals.

In some aspects, the techniques described herein relate to a wireless communications device wherein the transmit path is configurable in a third plurality of available states different than the first plurality of available states if the radio frequency front end module is operated in a second configuration of the plurality of available configurations.

### BRIEF DESCRIPTION OF THE DRAWINGS

FIG. 1 illustrates a block diagram of an exemplary RF FEM with a switching circuit operated under the control of a controller.

FIG. 2 illustrates a block diagram of an exemplary RF FEM configured to receive control signals from an external controller.

FIG. 3 illustrates block diagram of three RF FEMs corresponding to the block diagram of the exemplary RF FEM shown in FIG. 2.

FIG. 4 illustrates a block diagram of an exemplary RF FEM with an integrated controller enabling compatibility with different control signals and/or different control interfaces.

### DETAILED DESCRIPTION OF EMBODIMENTS

The following description of certain embodiments presents various descriptions of specific embodiments. However, the innovations described herein can be embodied in a multitude of different ways, for example, as defined and covered by the claims.

In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

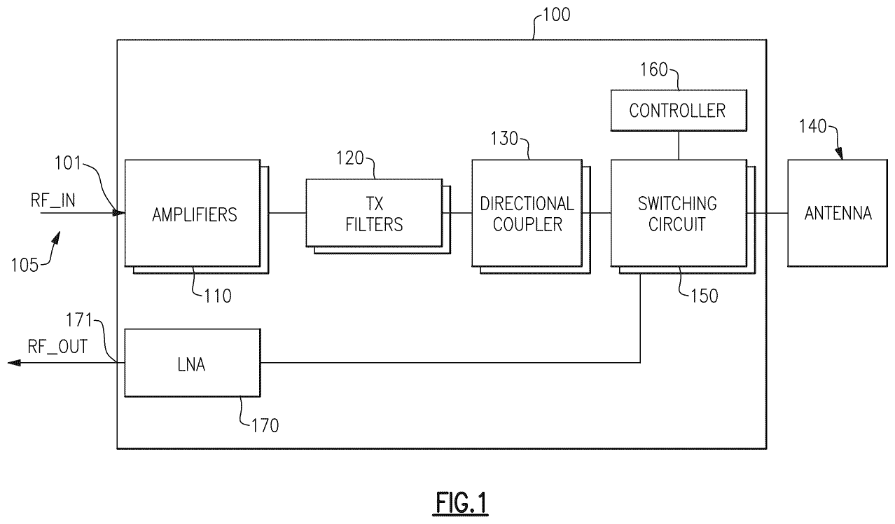

FIG. 1 illustrates a block diagram of an exemplary RF FEM 100 with a switching circuit 150 operated under the control of a controller 160. The RF FEM 100 may be used to transmit and receive RF signals. The RF FEM 100 shown in FIG. 1 includes a transmit path (Tx) configured to provide signals to an antenna 140 for transmission and a receive path (Rx) to receive signals from the antenna 140. In the transmit path (Tx), a power amplifier module 110 provides gain to an RF signal 105 input to the RF FEM 100 via an input port 101, producing an amplified RF signal. The power amplifier module 110 includes one or more power amplifiers (PAS).

The RF FEM 100 can further include a filtering module 120, which can include one or more filters. In some examples, a directional coupler 130 can be used to extract a portion of the power from the RF signal traveling between the power amplifier module 110 and an antenna 140 connected to the RF FEM 100. The antenna 140 can transmit the RF signal and can also receive RF signals. The switching circuit 150, also referred to as an antenna switch module (ASM), can be used to switch between a transmitting mode and receiving mode of the RF FEM 100, for example, or between different transmit or receive frequency bands and/or their combination. In certain examples, the switching circuit 150 can be operated under the control of a controller 160.

The RF FEM 100 can also include a receive path (Rx) configured to process signals received by the antenna 140 and provide the received signals to a signal processor (e.g., a transceiver) via an output port 171. The receive path (Rx) can include one or more low-noise amplifiers (LNA) 170 to amplify the signals received from the antenna. Although not shown, the receive path (Rx) can also include one or more filters for filtering the received signals.

In many cases, front end modules, such as the RF FEM 100, can be configured for use in WiFi systems. WiFi RF FEMs may include filters (e.g., filtering module 120) configured for specific WiFi operating frequencies and bands. In one example, for the 2.4 to 2.5 GHz WiFi band, filters may be applied to enhance channel performance (e.g., CH1 to CH11). In some examples, such filters may be applied or removed depending on the application. For example, the 2.4 to 2.5 GHz WiFi band filters may be applied for operation in the North American market while being optional or unnecessary for operation in the European market. Likewise, for WiFi UNII-1 through UNII-8, filters may be applied to separate the legacy UNII-1 through UNII-3 bands from the UNII-5 through UNII-8 bands and the filters may be removed for broadband applications covering UNII-1 through UNII-8.

As described above, it may be desirable to selectively apply/remove filters used with WiFi RF FEMs depending on the application (e.g., based on the manufacturer of the phone or other RF system in which the RF FEM is incorporated) or location (e.g., country) in which it is used. In some cases, to selectively apply/remove such filters, external switches can be utilized to either include the filter(s) or bypass the filter(s) to achieve desired RF FEM configurations.

The RF FEM may include a filter and a switch matrix configured to selectively apply or remove the filter from the transmit and/or receive paths of the RF FEM. In some embodiments, component impedances can be matched within the RF FEM to reduce losses and improve performance.

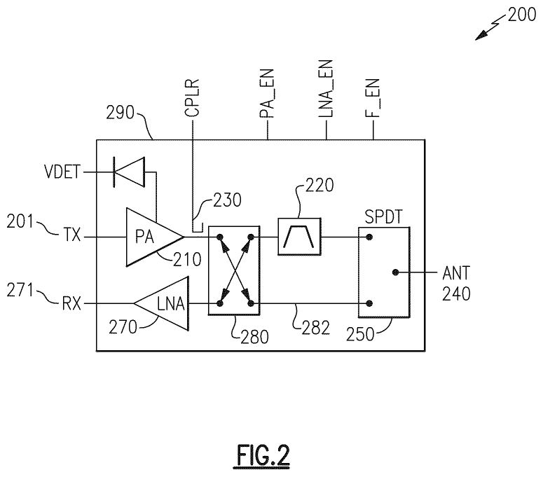

FIG. 2 illustrates a block diagram of an exemplary RF FEM 200 configured to receive control signals from an external controller (not shown). The controller may be configured to allow the RF FEM 200 to be controlled by multiple different logic tables generated by different RF systems such that the RF FEM 200 may support each of said different RF systems when the RF FEM 200 and the external controller are integrated in any one of said different RF systems.

In one example, the RF FEM 200 includes an input port 201, a power amplifier (PA) 210, a filter 220, a coupler 230, an antenna port 240, a switching circuit 250, an LNA 270, an output port 271, and a switch matrix 280. As shown, the components of the RF FEM 200 can be included in a package 290. In some examples, the components of the RF FEM 200 may be included on a single substrate; however, in other examples, the components may be included on two or more substrates included in the package 290.

The FEM 200 includes a transmit path (Tx) configured to provide signals to the antenna port 240 for transmission and a receive path (Rx) to receive signals from the antenna port 240. In the transmit path (Tx), the power amplifier module 210 provides gain to an RF signal input to the RF FEM 200 via the input port 201, producing an amplified RF signal. In some examples, the power amplifier module 210 can include multiple power amplifiers (and multiple gain stages).

In one example, the directional coupler 230 can be used to extract a portion of the power from the RF signal traveling between the power amplifier 210 and the antenna port 240. In some examples, the extracted portion of the RF signal is used to adjust the gain of the power amplifier 210. The antenna port 240 provides the RF signal to an antenna for transmission and also receives RF signals from the antenna 240. The switching circuit 250 can be used to switch between a transmitting mode and receiving mode of the RF FEM 200, for example, or between different transmit or receive frequency bands. In certain examples, the switching circuit 250 can be operated under the control of a controller (not shown). In some examples, the switching circuit 250 is configured as a single-pole double-throw (SPDT) switch.

The RF FEM 200 also includes a receive path (Rx) configured to process signals received at the antenna port 240 and provide the received signals to a signal processor (e.g., a transceiver) via the output port 271. The receive path (Rx) includes the LNA 270, which is configured to amplify the signals received from the antenna port 240.

In some examples, the RF FEM 200 is configured to receive one or more control signals. For example, a power amplifier enable signal (PA_EN), an LNA enable signal (LNA_EN), and a filter enable signal (F_EN). In one example, the filter enable signal is used to control or operate the switch matrix 280 and/or the switching circuit 250.

In one example, the switch matrix 280 is configured to selectively apply or remove the filter 220. For example, when the filter 220 is to be applied, the switch matrix 280 can be controlled such that RF signals in the transmit path (Tx) and/or the receive path (Rx) are provided through the filter 220. Likewise, when the filter 220 is to be removed, the switch matrix 280 can be controlled such that RF signals in the transmit path (Tx) and/or the receive path (Rx) bypass the filter 220 via a bypass path 282. In some examples, the filter 220 is a bulk acoustic wave (BAW) filter.

More specifically, the RF FEM 200 may be configured to operate in various modes of operation. For example, in a first transmit mode of operation, the switching circuit 250 and the switch matrix 280 are controlled such that the filter 220 is applied to the transmit path (Tx). In the first transmit mode of operation, the switching matrix 280 is controlled to couple the power amplifier 210 to the filter 220 and the switching circuit 250 is controlled to couple the filter 220 to the antenna 240. As such, in the first transmit mode of operation, RF signals in the transmit path (Tx) are amplified by the power amplifier 210 and filtered by the filter 220 before being provided to the antenna port 240 for transmission via the antenna. Likewise, in a second transmit mode of operation, the switching circuit 250 and the switch matrix 280 are controlled such that the filter 220 is removed from the transmit path (Tx). In the second transmit mode of operation, the switching matrix 280 is controlled to couple the power amplifier 210 to the bypass path 282 and the switching circuit 250 is controlled to couple the bypass path 282 to the antenna port 240. As such, in the second transmit mode of operation, RF signals in the transmit path (Tx) are amplified by the power amplifier 210 and provided to the antenna port 240 for transmission via the antenna, bypassing the filter 220.

Similarly, in a first receive mode of operation, the switching circuit 250 and the switch matrix 280 are controlled such that the filter 220 is applied to the receive path (Rx). In the first receive mode of operation, the switching circuit 250 is controlled to couple the filter 220 to the antenna port 240 and the switching matrix 280 is controlled to couple the filter 220 to the LNA 270. As such, in the first receive mode of operation, RF signals in the receive path (Rx) are filtered by the filter 220 and amplified by the LNA 270 before being provided to the output port 271. Likewise, in a second receive mode of operation, the switching circuit 250 and the switch matrix 280 are controlled such that the filter 220 is removed from the receive path (Rx). In the second receive mode of operation, the switching circuit 250 is controlled to couple the bypass path 282 to the antenna port 240 and the switching matrix 280 is controlled to couple the bypass path 282 to the LNA 270. As such, in the second receive mode of operation, RF signals in the receive path (Rx) are amplified by the LNA 270 and provided to the output port 271, bypassing the filter 220.

In one example, the RF FEM 200 is configured for use in WiFi systems. In some examples, the filter 220 can be configured for specific WiFi operating frequencies or bands (e.g., 2.4 GHz). As described above, filters in WiFi RF FEMs may be applied or removed depending on the application or location of use. As such, the operating modes described above may correspond to specific WiFi applications. For example, the filter 220 may be applied for operation in the North American market while being removed for operation in the European market. As such, the RF FEM 200 may be configured to operate in the first transmit mode and/or the first receive mode for operation in the North American market and in the second transmit mode and/or the second receive mode for operation in the European market. Likewise, the RF FEM 200 may be configured to operate in the first transmit mode and/or the first receive mode for 5 to 6 GHz and 6 to 7 GHz WiFi applications and in the second transmit mode and/or the second receive mode for broadband WiFi applications.

In some examples, the filter 220 may be applied or removed such that the RF FEM 200 operates in accordance with one or more performance regulations. In one example, the filter 220 may be applied or removed to meet one or more performance regulations corresponding to the application or location of use. For example, the filter 220 may be applied in a first application or location (e.g., North American market) to meet out of band (OOB) noise regulations. Likewise, the filter 220 may be removed in a second application of location (e.g., European market) with reduced or relaxed OOB noise regulations.

Similarly, the filter 220 may be applied or removed to improve performance on a channel-by-channel basis. For example, the filter 220 may be applied to improve the performance of outer WiFi channels (e.g., CH1, CH11, etc.) by minimizing OOB noise generated by the power amplifier 210 and/or filtering outside noise. Likewise, the filter 220 may be removed for center WiFi channels (e.g., CH6) when minimal filtering is needed. In some examples, by selectively applying the filter 220 on a channel-by-channel basis, the efficiency of the amplifiers 210, 270 can be improved.

In addition, applying the filter 220 on a channel-by-channel basis can improve the performance (e.g., range) of the RF FEM 200. For example, by selectively applying the filter 220 to outer WiFi channels, the power amplifier 210 may provide desired output power levels for optimal performance without generating unacceptable levels of OOB noise. In one example, the RF FEM 200 may be operated such that the output power levels of the outer WiFi channels are substantially the same as the output power levels of the inner WiFi channels. As such, performance similar to that of the center WiFi channels may be achieved for the outer WiFi channels.

As shown in FIG. 2, the components of the RF FEM 200 (e.g., the filter 220, the switch matrix 280, etc.) may be included in a package 290. In some examples, being that the components of the RF FEM 200 are included in a compact arrangement within the package 290, overall path losses between components can be reduced. In addition, the components of the RF FEM 200 may be matched to different impedances (i.e., non-standard impedances) and/or directly matched to one another. For example, being that the switch matrix 280 and the filter 220 are included within the RF FEM 200 (and the package 290), other components may be matched closely to the impedances of the switch matrix 280 and/or the filter 220 (or vice versa), rather than a standard impedance (e.g., 50 ohms). Likewise, the output of the power amplifier 210 may have a first impedance (e.g., 2-6 ohms) and the filter 220 may have a second impedance (e.g., 30 Ohms). Rather than matching the both the power amplifier 210 and the filter 220 to a standard impedance (e.g., 50 ohms), the output of the power amplifier 210 may be matched directly to the second impedance of the filter 220. As such, performance within the RF FEM 200 may be more consistent due to improved impedance control and minimized impedance transformation losses.

In certain examples, by minimizing impedance transformation losses, the RF FEM 200 can operate at reduced power levels. For example, power consumption of the RF FEM 200 may be lower due to improved component-to-component impedance matching, allowing the RF FEM 200 to provide maximum output power with improved efficiency. As such, in some examples, the RF FEM 200 may include components with lower power ratings, reducing size and cost of the RF FEM 200.

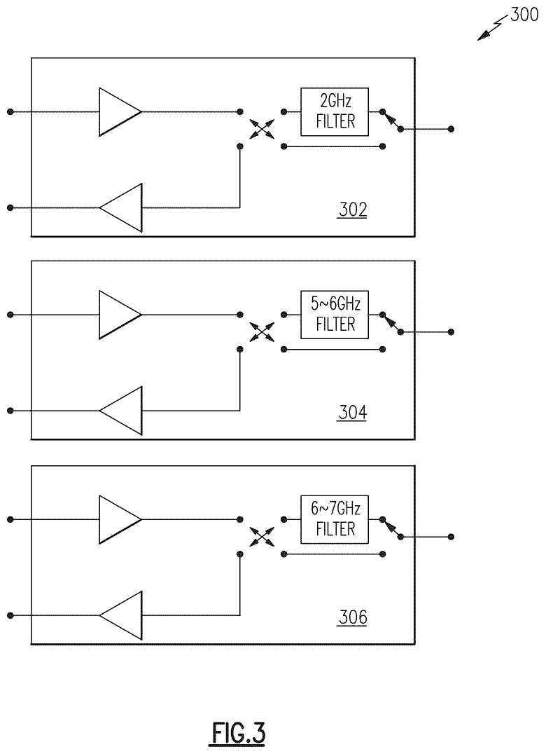

As described above, the RF FEM 200 may be configured as a WiFi RF FEM and included in a wireless device that communicates over WiFi. In some examples, multiple RF FEMs may be included in such wireless devices to provide additional configurability options. For example, FIG. 3 is a block diagram illustrating a RF FEM arrangement 300 in accordance with aspects described herein. As shown, the RF FEM arrangement 300 includes a first RF FEM 302, a second RF FEM 304, and a third RF FEM 306. In one example, each of the RF FEMs 302, 304, and 306 corresponds to the RF FEM 200 of FIG. 2. In some examples, the RF FEMs 302, 304, and 306 may be configured for different WiFi operating frequencies (or bands). For example, the first RF FEM 302 may be configured for 2 GHz WiFi applications, the second RF FEM 304 may be configured for 5 to 6 GHz WiFi applications, and the third RF FEM 306 may be configured for 6 to 7 GHz WiFi applications. In some examples, each of the RF FEMs 302, 304, and 306 may be coupled to a common antenna port (e.g., antenna port 240). In other examples, each of the RF FEMs 302, 304, and 306 may be coupled to different antennae, or the lower frequency RF FEM 302 may be coupled to one antenna, and the mid and high frequency RF FEMs 304 and 306 may be coupled to a different antenna. In still other examples, the RF FEM arrangement 300 may include a different number of RF FEMs and the RF FEMs may be configured for different frequencies and/or applications.

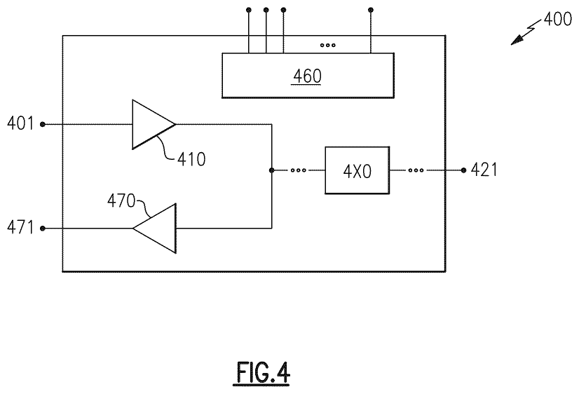

FIG. 4 illustrates a block diagram of an exemplary RF FEM 400 with an integrated controller 460 enabling compatibility with different control signals and/or different control interfaces.

The controller 460 may be configured to allow the RF FEM 400 to be controlled by multiple different logic tables generated by different RF systems such that the RF FEM 400 may support each of said different RF systems when the RF FEM 400 is integrated in any one of said different RF systems.

The controller 460 is configurable to operate the RF FEM 400 according to the configuration of the RF system in which the RF FEM 400 is included. In other words, the controller 460 is configurable to operate the RF FEM 400 according to control signals from different RF systems.

The RF FEM 400 may, for instance, be configurable to operate according to control signals from a first RF system from a first supplier and configurable to operate according to control signals from a second RF system from a second supplier. The first RF system and the second RF system may be different RF systems in that the RF systems have different Tx states and/or Rx states, e.g. multiple, non-overlapping and/or partially overlapping Tx states and/or Rx states. States may include but are not limited to Tx high gain, Tx low gain, Rx high gain, Rx mid gain, Rx low gain, RF feedback for Tx power control and linearization, and DC Feedback for Tx power control.

The controller 460 may be configured to detect the configuration of the RF system in which the RF FEM 400 is included. The configuration of the RF system in which the RF FEM 400 is included may for instance be detected by using at least one general purpose input/output (GPIO) pin coupled to the controller 460. The RF FEM 400 may comprise two dedicated GPIO pins coupled to the controller 460 to provide the configurability to different RF systems. The RF FEM 400 may also comprise three or more GPIO pins to provide the configurability to different RF systems.

The controller 460 may be adaptable and/or updatable to requirements of the RF system in which the RF FEM 400 is included by software without requiring adaptation and/or update of a hardware of the RF FEM. The RF FEM 400 may comprise memory to store different configurations and/or versions of the RF systems in which the RF FEM 400 may be included.

The RF FEM 400 may comprise an LNA 470, which may be coupled into a Rx path between a port 471 and, e.g., a port 421. The RF FEM 400 may comprise a PA 410, which may be coupled into a Tx path between a port 401 and, e.g., the port 421. The Rx path and/or the Tx may comprise circuitry 4x0, for instance the circuitry described in relation to FIG. 1, FIG. 2, and/or FIG. 3, such as any one or more of the filters, the coupler, and/or the switching circuit shown therein.

It should be appreciated that while the RF FEMs, have been described above with reference to various WiFi applications, similar RF FEM architectures may be used in different wireless applications. For example, the RF FEMs may be configured for use in wireless local area network (WLAN), ultra-wideband (UWB), wireless personal area network (WNPAN), 4G cellular, LTE cellular, 5G cellular, and/or 6G cellular applications.

In some examples, one or more components of the RF FEM 200 may include Gallium Arsenide (GaAs), Heterojunction Bipolar Transistors (HBT) and/or Silicon Germanium (SiGe) HBTs. In certain examples, the RF FEM 200 or one or more components of the RF FEM hay be fabricated using silicon on insulator (SOI) techniques.

Embodiments of the RF FEMs described herein may be advantageously used in a variety of electronic devices. Examples of the electronic devices can include, but are not limited to, consumer electronic products, parts of the consumer electronic products, electronic test equipment, cellular communications infrastructure such as a base station, etc. Examples of the electronic devices can include, but are not limited to, an IEEE 802.11ax access point, a router, a gateway, a mobile phone such as a smart phone, a telephone, a television, a computer monitor, a computer, a modem, a hand held computer, a laptop computer, a tablet computer, an electronic book reader, a wearable computer such as a smart watch, a personal digital assistant (PDA), an appliance, such as a microwave, refrigerator, or other appliance, an automobile, a stereo system, a DVD player, a CD player, a digital music player such as an MP3 player, a radio, a camcorder, a camera, a digital camera, a portable memory chip, a health care monitoring device, a vehicular electronics system such as an automotive electronics system or an avionics electronic system, a peripheral device, a wrist watch, a clock, etc. Further, the electronic devices can include unfinished products.

Aspects of this disclosure can be implemented in various electronic devices. Examples of the electronic devices can include, but are not limited to, consumer electronic products, parts of the consumer electronic products such as packaged radio frequency modules, radio frequency filter die, uplink wireless communication devices, wireless communication infrastructure, electronic test equipment, etc. Examples of the electronic devices can include, but are not limited to, a mobile phone such as a smart phone, a wearable computing device such as a smart watch or an ear piece or smart eyeglasses or virtual reality equipment, a telephone, a television, a computer monitor, a computer, a modem, a hand-held computer, a laptop computer, a tablet computer, a microwave, a refrigerator, a vehicular electronics system such as an automotive electronics system, a robot such as an industrial robot, an Internet of things device, a stereo system, a digital music player, a radio, IoT radios, a camera such as a digital camera, a portable memory chip, a home appliance such as a washer or a dryer, a peripheral device, a wrist watch, a clock, etc. Further, the electronic devices can include unfinished products.

Unless the context indicates otherwise, throughout the description and the claims, the words “comprise,” “comprising,” “include,” “including” and the like are to generally be construed in an inclusive sense, as opposed to an exclusive or exhaustive sense; that is to say, in the sense of “including, but not limited to.” Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. The word “coupled”, as generally used herein, refers to two or more elements that may be either directly coupled, or coupled by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above detailed description using the singular or plural number may also include the plural or singular number respectively.

While certain embodiments have been described, these embodiments have been presented by way of example only, and are not intended to limit the scope of the disclosure. Indeed, the novel resonators, filters, multiplexer, devices, modules, wireless communication devices, apparatus, methods, and systems described herein may be embodied in a variety of other forms. Furthermore, various omissions, substitutions and changes in the form of the resonators, filters, multiplexer, devices, modules, wireless communication devices, apparatus, methods, and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and/or acts of the various embodiments described above can be combined to provide further embodiments. The accompanying claims and their equivalents are intended to cover such forms or modifications as would fall within the scope of the disclosure.

What is claimed is:

1. A radio frequency front end module comprising:
a controller configurable, based on a control input, to select from operating the radio frequency front end module in a first configuration or a second configuration, the first configuration and the second configuration corresponding to different radio frequency host systems; and
a transmit path including a power amplifier, and a receive path including a low-noise amplifier, the transmit path configurable in a first plurality of available states when the radio frequency front end module is operating in the first configuration and a second plurality of available states when the radio frequency front end module is operating in the second configuration, the receive path configurable in a third plurality of available states when the radio frequency front end module is operating in the first configuration and a fourth plurality of available states when the radio frequency front end module is operating in the second configuration.

2. The radio frequency front end module of claim 1 wherein the first plurality of available states partially overlaps with the second plurality of available states.

3. The radio frequency front end module of claim 2 wherein the third plurality of available states partially overlaps with the fourth plurality of available states.

4. The radio frequency front end module of claim 1 further comprising at least one general purpose input/output pin coupled to the controller, the controller selecting the first configuration or the second configuration based on information received on the at least one general purpose input/output pin that identifies a host radio frequency system in which the radio frequency front end module is included.

5. The radio frequency front end module of claim 1 wherein the first configuration corresponds to a host radio frequency system from a first supplier and the second configuration corresponds to a host radio frequency system from a second supplier.

6. The radio frequency front end module of claim 1 further comprising a package containing the controller, the transmit path, and the receive path.

7. The radio frequency front end module of claim 1 further comprising one or more switches configured to selectively connect the transmit path or the receive path to an antenna port of the radio frequency front end module.

8. The radio frequency front end module of claim 7 further comprising a filter, the controller configured to selectively configure the one or more switches to include the filter in the transmit path or the receive path depending on the current state of the respective path.

9. The radio frequency front end module of claim 1 wherein the first plurality of available states are different than the second plurality of available states.

10. The radio frequency front end module of claim 9 wherein the third plurality of available states are different than the fourth plurality of available states.

11. A mobile device comprising:
an antenna; and
a host radio frequency system including a packaged front end module, the packaged front end module including a controller configurable, based on a control input, to select from operating the packaged front end module in a first configuration or a second configuration, the first configuration and the second configuration corresponding to different radio frequency host systems, the packaged front end module further including a transmit path including a power amplifier, and a receive path including a low-noise amplifier, the transmit path configurable in a first plurality of available states when the packaged front end module is operating in the first configuration and a second plurality of available states when the packaged front end module is operating in the second configuration, the receive path configurable in a third plurality of available states when the packaged front end module is operating in the first configuration and a fourth plurality of available states when the packaged front end module is operating in the second configuration.

12. The mobile device of claim 11 wherein the first configuration corresponds to the host radio frequency system from a first supplier and the second configuration corresponds to a different host radio frequency system from a second supplier.

13. The mobile device of claim 12 wherein the first plurality of available states partially overlaps with the second plurality of available states.

14. The mobile device of claim 13 wherein the third plurality of available states partially overlaps with the fourth plurality of available states.

15. The mobile device of claim 11 wherein the controller is configured to be adapted to requirements of a radio frequency system in which the packaged front end module is included by software without requiring an adaptation or an update of hardware components of the packaged front end module.

16. The mobile device of claim 11 further comprising one or more switches configured to selectively connect the transmit path or the receive path to an antenna port of the front end module.

17. The mobile device of claim 16 further comprising an acoustic wave filter, the controller configured to selectively configure the one or more switches to include the acoustic wave filter in the transmit path in at least one state of the first plurality of available states.

18. A wireless communication device comprising:
a radio frequency system of a first type of radio frequency system and configured to generate control signals; and
a radio frequency front end module including a control interface configured to receive the control signals and, based on the control signals, select a first configuration to operate the radio frequency front end module in from a plurality of available configurations, the first configuration corresponding to the first type of radio frequency system, the radio frequency front end module further including a transmit path and a receive path, the transmit path configurable in a first plurality of available states when the radio frequency front end module is operating in the first configuration, the receive path configurable in a second plurality of available states when the radio frequency front end module is operating in the first configuration.

19. The wireless communications device of claim 18 wherein the radio frequency front end module further includes a controller configured to select the first operating configuration based on the control signals.

20. The wireless communications device of claim 18 wherein the transmit path is configurable in a third plurality of available states different than the first plurality of available states if the radio frequency front end module is operated in a second configuration of the plurality of available configurations.
